(19) United States
(12) Patent Application Publication
(10) Pub. No.: US 2011/0117827 A1
(43) Pub. Date: May 19, 2011

(54) COIN HOPPER WITH A PUSH-UP COIN PASSAGE

(76) Inventors: Chia-Hao CHANG, Taipei City (TW); Tzu-Feng Tseng, Taipei City (TW); Sung-Ching Lin, Taipei (TW)

(21) Appl. No.: 12/709,210

(22) Filed: Feb. 19, 2010

(30) Foreign Application Priority Data
Nov. 18, 2009 (TW) 098139161

(51) Int. Cl. G07D 1/00

(52) U.S. Cl. 453/57

(57) ABSTRACT

A coin hopper includes a coin dispensing unit having a hopper body, a coin outlet, a rotating disc mounted in the hopper body and a power drive for rotating the rotating disc to dispense coins out of the hopper body through the coin outlet, and a rack having a coin passage upwardly extending from the coin outlet for guiding coins out of the coin outlet one by one and a plurality of anti-backward devices arranged along the length of the coin passage, each anti-backward device having a floating member movable up and down in the coin passage for allowing forward movement of coins one by one along the coin passage and avoiding jamming or backward movement of dispensed coins.

This application claims the priority benefit of Taiwan patent application number 098139161 filed on Nov. 18, 2009.

### BACKGROUND OF THE INVENTION

1. Field of the Invention

The present invention relates to coin dispensing technology and more particularly, to a coin hopper with a push-up coin passage, which has a track extended from the coin outlet of a coin dispensing unit thereof for guiding dispensed coins to a coin-ejection device and a plurality of anti-backward devices installed in the track and using floating members to prohibit backward movement or stacking of dispensed coins.

2. Description of the Related Art

Many different coin hoppers are commercially available and intensively used in coin exchange machines, gambling machines, amusement machines and vending machines for sending out or issuing coins or tokens one by one. However, coins or tokens of different thicknesses, sizes and/or shapes may be used in different countries or different machines.

A conventional coin hopper is known using a motor to rotate a rotating disc for dispensing coins/tokens. The rotating disc has a plurality of equiangularly spaced pins. A guide member and a micro switch are respectively mounted in the inner side and outer side of the coin outlet of the coin hopper. During rotation of the rotating disc, coins/tokens are pushed one by one by the pins of the rotating disc toward the coin outlet and then guided out of the coin outlet by the guide member. When one coin/token passes through the coin outlet, the micro switch will be activated, achieving counting the number of the dispensed coin/token.

Further, because the total weight of the coins/tokens that are accommodated in the hopper body of the coin hopper is heavy and for the sake of lowering the gravity center to assure machine stability during transportation, the hopper body is set at the bottom side and a conveying means or track means is provided between the rotating disc and the coin outlet to guide each dispensed coin/token to the coin outlet that is disposed at a relatively higher place. Thus, the user can pick up each dispensed coin when sitting or standing in front of the machine.

FIG. 8 illustrates a track for coin hopper according to the prior art design. As illustrated, the track A comprises a bottom plate A1, two rails A2 bilaterally arranged at the top side of the bottom plate A1, a coin passage A3 defined between the two rails A2 above the bottom plate A1, a locating plate A4 transversely affixed to the two rails A2 above the coin passage A3 by fastening members A41 and a plurality of leaf springs A5 arranged in a stack and affixed to the locating plate A4 in such a manner that the arched press portions A51 of the leaf springs A5 are arranged in line and suspending in the coin passage A3. When the rotating disc of the coin hopper is rotated by the motor through the transmission mechanism to dispense coins/tokens into the coin passage A3 of the track A one by one, the arched press portions A51 of the leaf springs A5 are pressed on the dispensed coins/token B, preventing stacking of the coins/tokens B. This structure of coin hopper is functional, however due to the effect of the holding down pressure from the arched press portions A51 of the leaf springs A5, the rotating disc receives a great resistance during its rotation. In order to overcome this great resistance, the output power of the motor must be relatively increased. However, increasing the capacity of the motor relatively increases the cost. Further, due to strong resistance from the leaf springs A5, a heavy vibration is produced during operation of the motor to rotate the rotating disc at a high speed. In consequence, the component parts of the transmission mechanism and the motor may wear quickly with use or may be damaged easily during operation.

Therefore, it is desirable to provide a coin hopper that eliminates the aforesaid problem.

### SUMMARY OF THE INVENTION

The present invention has been accomplished under the circumstances in view. It is therefore the main object of the present invention to provide a coin hopper, which is practical for dispensing coins/tokens of different shapes, sizes and thickness without changing any components. It is still another object of the present invention to provide a coin hopper, which has a coin jam-free, inexpensive and durable design for longer lifespan.

To achieve these and other objects of the present invention, a coin hopper comprises a coin dispensing unit and a track. The coin dispensing unit comprises a hopper body, a coin outlet, a rotating disc mounted in the hopper body and a power drive adapted for rotating the rotating disc to dispense coins out of the hopper body through the coin outlet. The track is connected to the coin dispensing unit, comprising an arched wall portion smoothly upwardly curved from the coin outlet, a flat wall portion vertically upwardly extending from the top side of the arched wall portion remote from the coin outlet, a coin passage defined by the arched wall portion and the flat wall portion and connected to the coin outlet for guiding coins out of the coin outlet one by one, and a plurality of anti-backward devices arranged along the length of the coin passage above the arched wall portion and the flat wall portion. Each anti-backward device comprises a floating member movable up and down in the coin passage for allowing forward movement of coins one by one along the coin passage and prohibiting coins from backward movement.

Further, the track comprises a bottom panel formed of the arched wall portion and the flat wall portion and extending along the coin passage at a bottom side, two narrow elongated guide bars respectively arranged at left and right sides relative to the coin passage and a cover plate covered on the two narrow elongated guide bars above the coin passage. Each anti-backward device further comprises a plurality of constraint grooves respectively formed in the narrow elongated guide bars and the cover plate for accommodating the associating floating member. Each constraint groove has a bottom bearing surface that gradually reduces in width in a direction away from the coin passage.

The design of the anti-backward devices allows coins to push the floating members upwards in the associating constraint grooves so that coins can be moved upwards along the arched wall portion of smoothly at a predetermined sloping angle with less friction. Thus, the motor can rotate the rotating disc to dispense coins smoothly. Therefore, it is not necessary to upgrade the capacity of the motor or to enhance the structural strength of the track, saving the cost.

Further, by means of using the dispensed coins to push the floating members of the anti-backward devices upwards, the force of inserting the dispensed coins into the coin passage is low. After insertion of one coin into the coin passage beneath two or more floating members, the effect of self-gravity and friction of the dispensed coin causes the respective floating members to move downwards to the ends of the bottom bearing surfaces of the respective constraint grooves and then to hold down the dispensed coin, avoiding backward movement of the dispensed coin. Therefore, the coin hopper of the present invention has low failure rate and excellent anti-backward function characteristics and fits different sizes of coins.

### BRIEF DESCRIPTION OF THE DRAWINGS

FIG. 1 is an elevational view of a coin hopper in accordance with the present invention.

FIG. 2 is an exploded view of the coin hopper in accordance with the present invention.

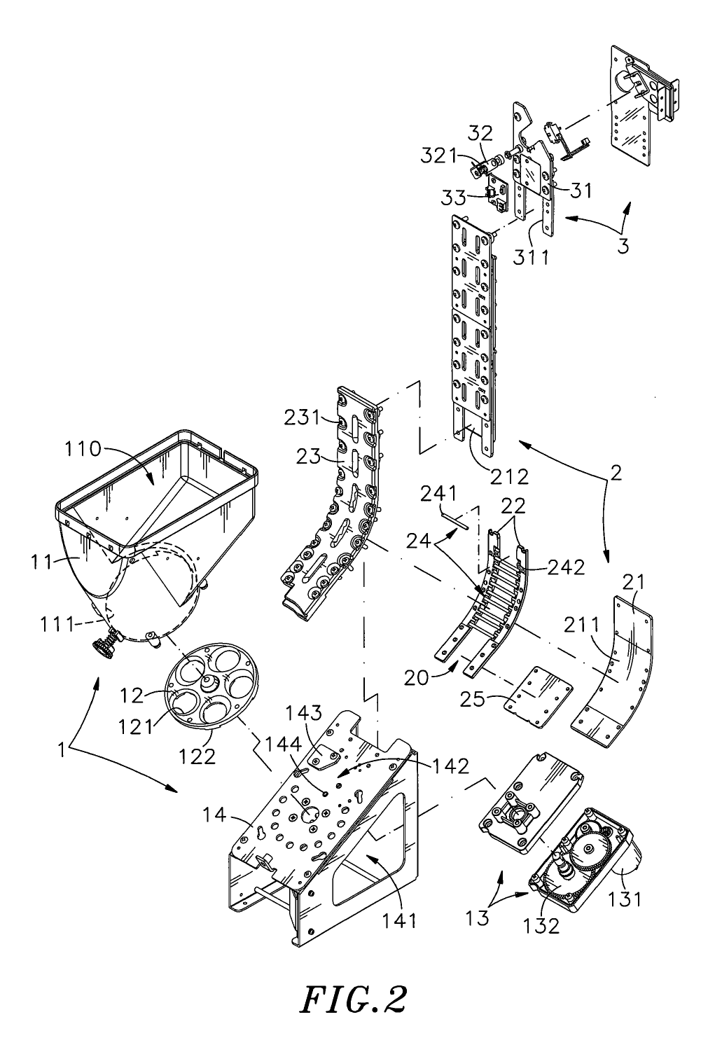

FIG. 3 is an exploded view of the track of the coin hopper in accordance with the present invention.

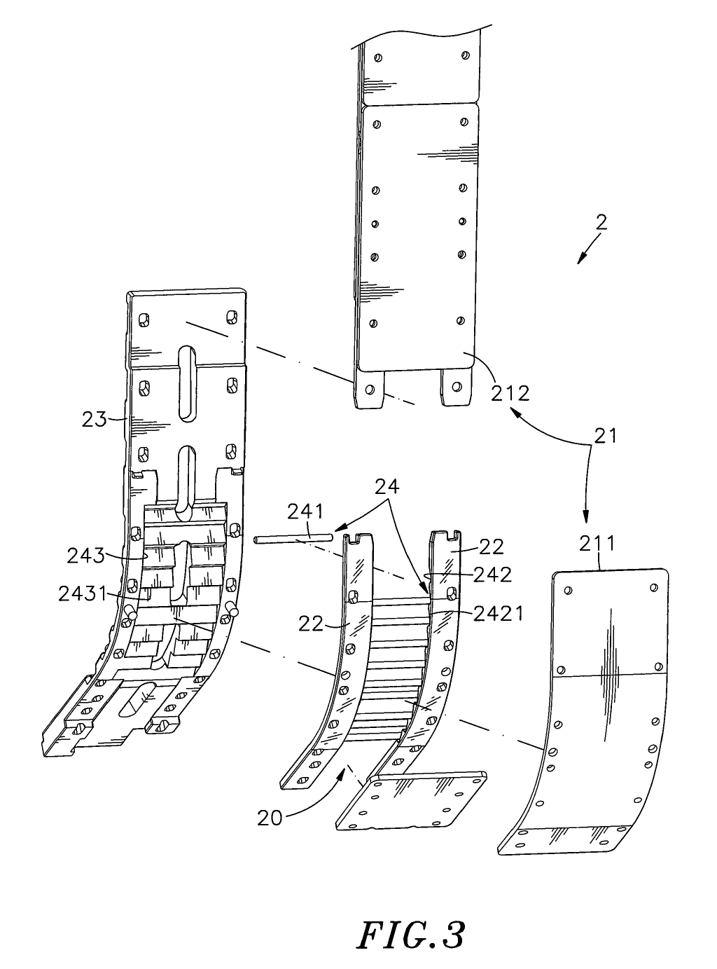

FIG. 4 is a sectional side view of the present invention, showing the status of the coin hopper before operation.

FIG. 5 is a top view of the present invention, showing the status of the coin hopper before operation.

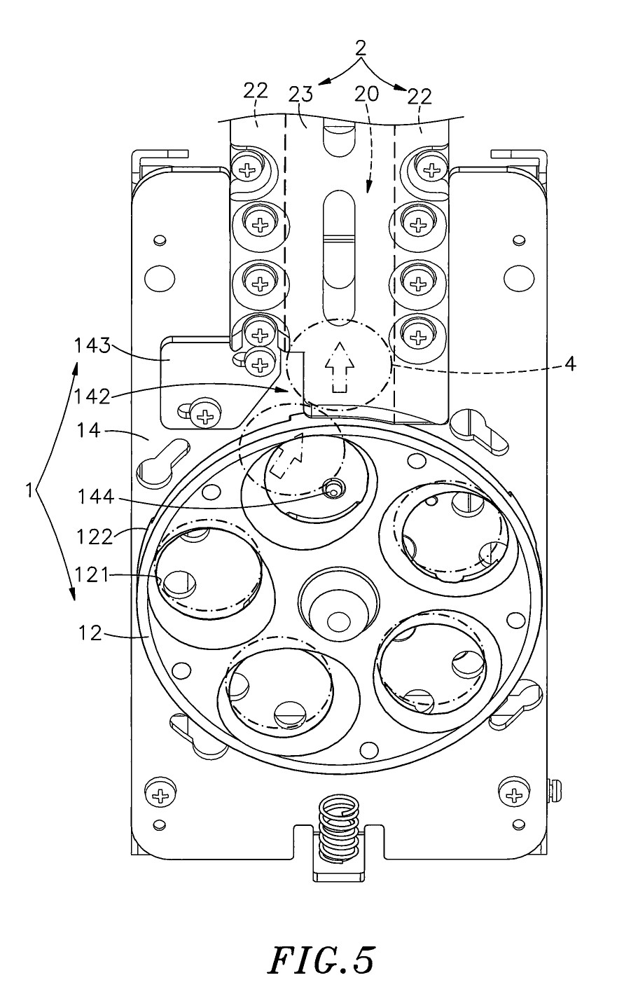

FIG. 6 is a sectional side view of the present invention, showing an operation status of the coin hopper (I).

FIG. 7 is a sectional side view of the present invention, showing an operation status of the coin hopper (II).

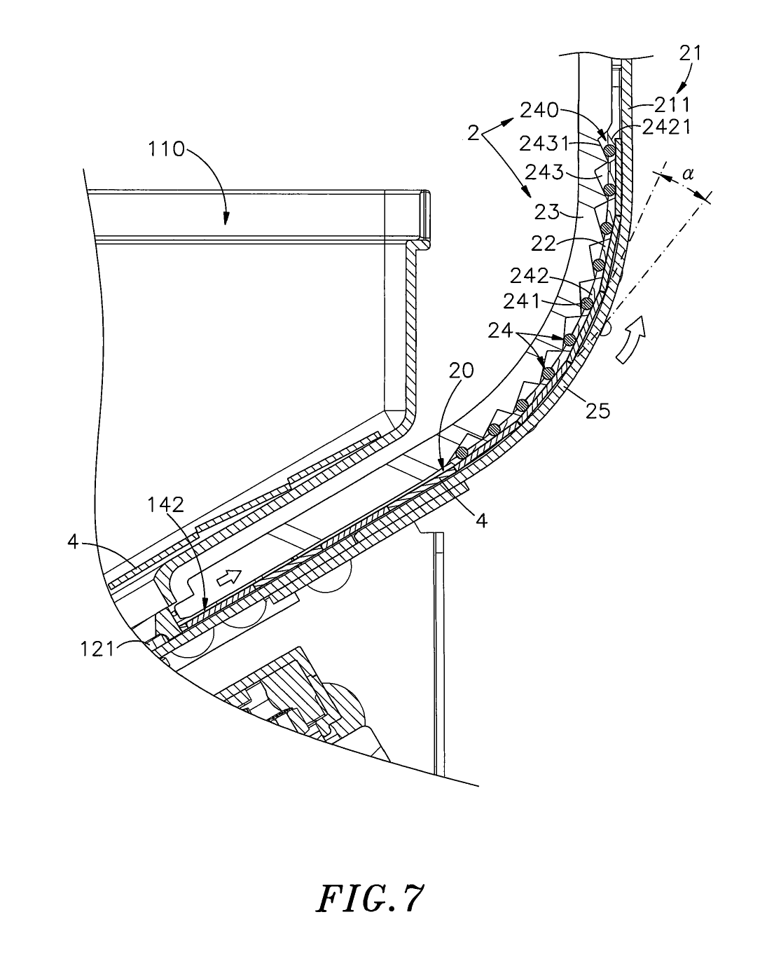

FIG. 8 illustrates a track for a coin hopper according to the prior art.

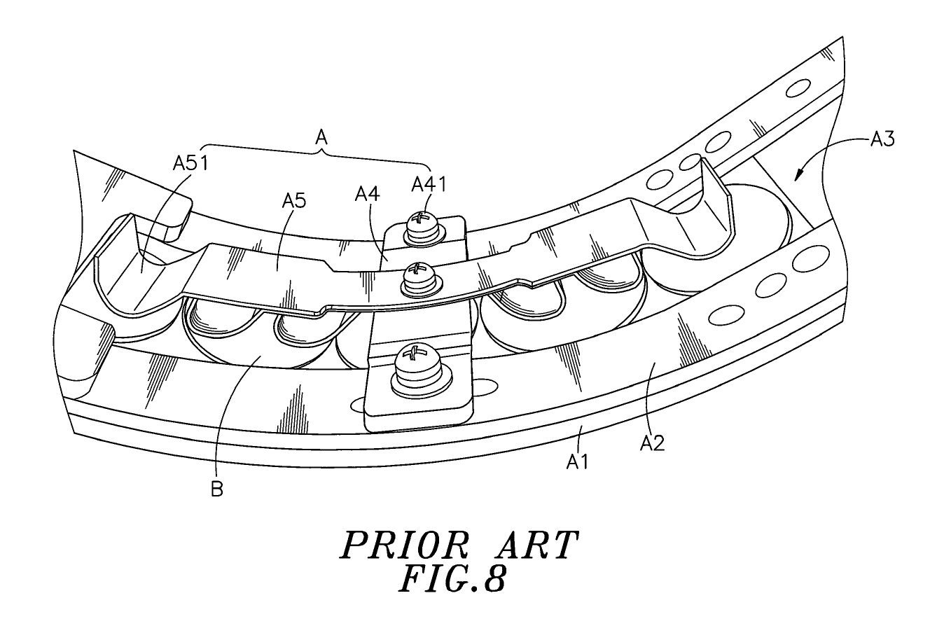

### DETAILED DESCRIPTION OF THE PREFERRED EMBODIMENT

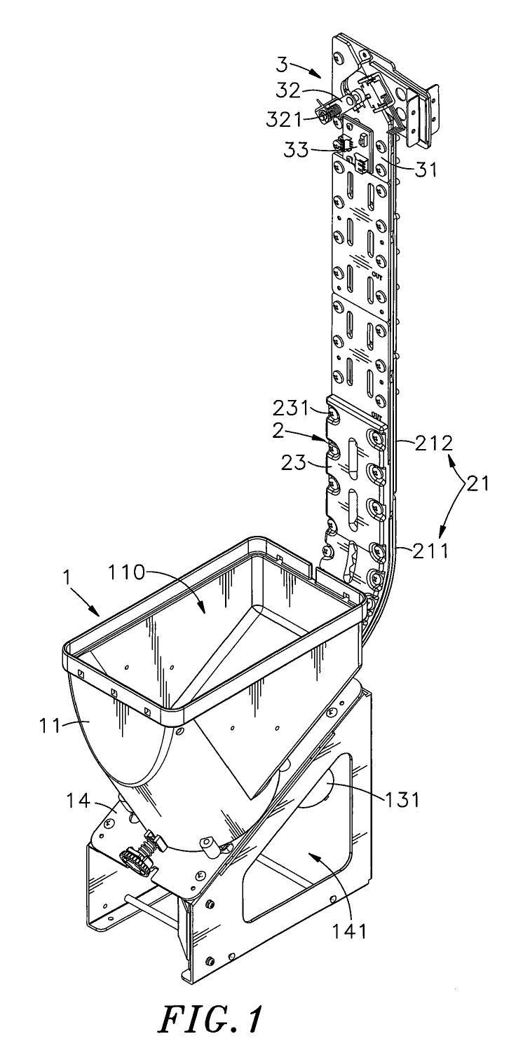

Referring to FIGS. 1˜4, a coin hopper is shown comprising a coin dispensing unit 1, a track 2 and a coin-ejection device 3.

The coin dispensing unit 1 comprises a hopper body 11, a rotation disc 12, a power drive 13 and a base frame 14. The hopper body 11 has an accommodation chamber 110 defined therein for receiving coins 4, a constricted bottom hole 111 disposed at the bottom side of the accommodation chamber 110. The rotating disc 12 has a plurality of coin holes 121 equiangularly spaced around the center thereof and a push block 122 protruded from the periphery. The power drive 13 is mounted in a bottom chamber 141 inside the base frame 14, comprising a motor 131 and a transmission mechanism 132 driven by the motor 131 to rotate the rotating disc 12. The base frame 14 has a downwardly extending sloping top wall defining with the bottom wall of the hopper body 11 a coin outlet 142, a guide portion 143 and a plurality of stop rods 144 disposed in the coin outlet 142.

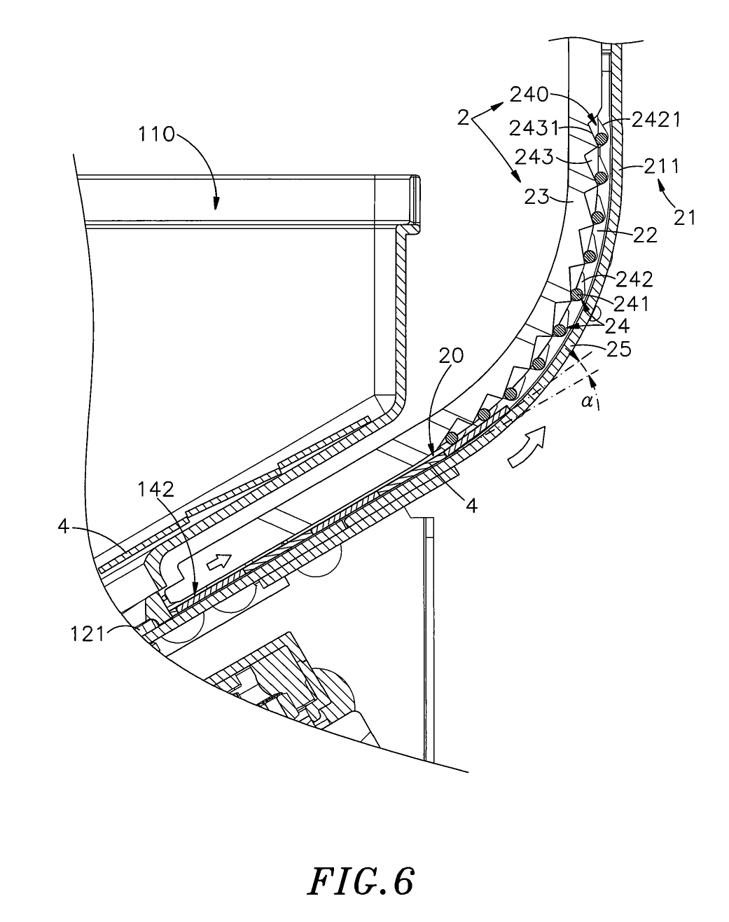

The track 2 defines a coin passage 20 connected to the coin outlet 142 of the coin dispensing unit 1 for guiding coins away from the coin outlet 142. The track 2 includes a bottom panel 21, which extends along the bottom side of the coin passage 20 and has an arched wall portion 211 extending from the coin outlet 142 and a flat wall portion 212 extending upwardly from the top side of the arched wall portion 211, two narrow elongated guide bars 22 respectively arranged at the left and right sides relative to the coin passage 20, a cover plate 23 covered on the two narrow elongated guide bars 22 above the coin passage 20, fastening members 231 mounted in the cover plate 23 and inserted through the guide bars 22 and then affixed to the bottom panel 21 to secure the cover plate 23, the guide bars 22 and the bottom panel 21 together, a anti-backward device 24 set in the coin passage 20 between the guide bars 22 and the cover plate 23 and a mounting plate 25 connected between the bottom panel 21 and the base frame 14 of the coin dispensing unit 1. Each anti-backward device 24 comprises a floating member 241 and constraint grooves 242;243 respectively formed in the guide bars 22 and the cover plate 23. Each constraint groove 242 or 243 has a bottom bearing surface 2421 or 2431 gradually reducing in width in a direction away from the coin passage 20. Further, each anti-backward device 24 defines a receiving space 240 in between the bottom bearing surfaces 2421 of the constraint grooves 242 on the guide bars 22 and the bottom bearing surface 2431 of the constraint groove 243 on the cover plate 23. The floating member 241 is set in the receiving space 240 and movable therein by a coin 4 (see FIG. 6).

The coin-ejection device 3 is located on the top side of the track 2, comprising a guide plate 31 that defines a coin output port 311 in communication with the coin passage 20, a coin-ejection element 32 pivotally connected to the guide plate 31 and biasable by a coin 4, a spring member 321 mounted on the bottom side of the coin-ejection element 32 and a sensor module 33 installed in the guide plate 31 and adapted to detect the presence of a coin 4 in the coin output port 311.

During installation, fixedly connect the mounting plate 25 between the bottom panel 21 and the base frame 14 of the coin dispensing unit 1 to keep the coin passage 20 of the track 2 in alignment with the coin outlet 142 of the base frame 14, and then affix the coin-ejection device 3 to the top side of the track 2, and then fasten up the fastening members 231 to affix the cover plate 23, the guide bars 22 and the bottom panel 21 together and also to affix the guide plate 31 to the guide bars 22 and the cover plate 23, keeping the coin output port 311 of the guide plate 31 of the coin-ejection device 3 in communication with the coin passage 20. At this time, the coin hopper is well assembled, and the track 2 curves upwardly backwards from the base frame 14 and then extends vertically upwards.

As stated above, the track 2 is formed of the bottom panel 21, the guide bars 22 and the cover plate 23, defining therein the said coin passage 20 that is surrounded by the bottom panel 21, the guide bars 22 and the cover plate 23. Further, the bottom panel 21 can be a single piece design. Alternatively, the arched wall portion 211 and the flat wall portion 212 can be separately made and then affixed together to constitute the bottom panel 21.

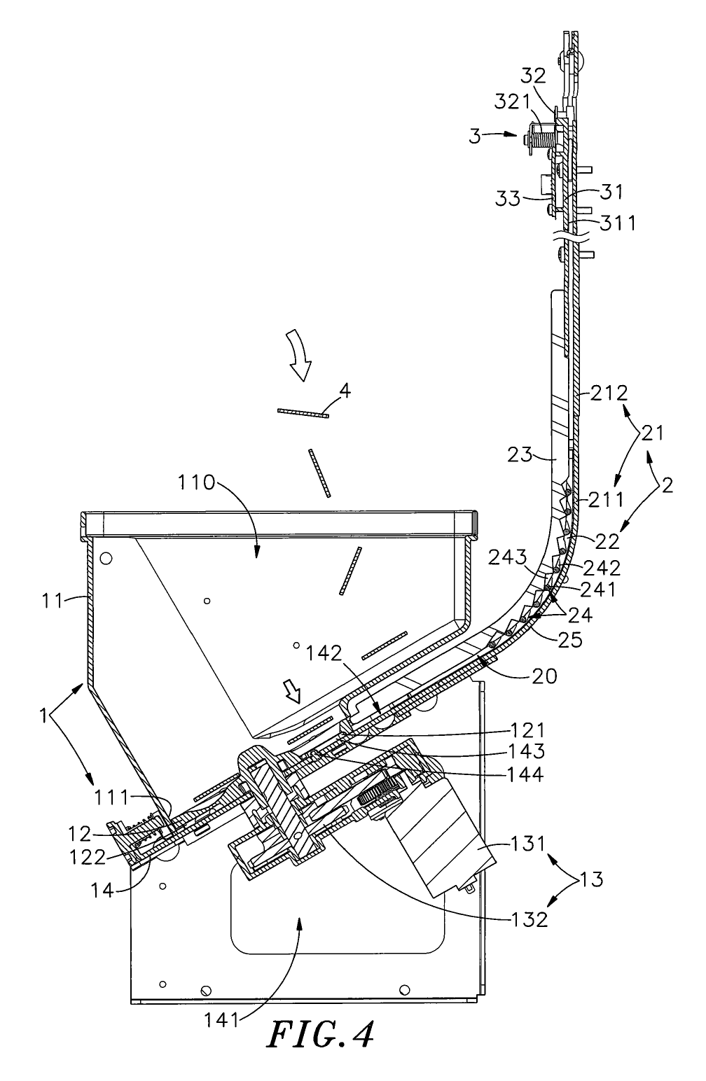

Referring to FIGS. 4˜7, the angular position of the guide portion 143 in the coin outlet 142 of the base frame 14 can be properly adjusted subject to the thickness and size of the coins 4 to be dispensed. After loading of coins 4 in the accommodation chamber 110 of the hopper body 11, the motor 131 of the power drive 13 can be started to rotate the transmission mechanism 132 and the rotating disc 12, causing coins 4 to fall to the coin holes 121 in a proper order. When one coin 4 falls to one coin hole 121, the coin 4 will be pushed by the push block 122 of the rotating disc 12 to stop against the stop rods 144 and to move along the guide portion 143. Subject to the centrifugal force produced during rotation of the rotating disc 12, each fallen coin 4 will be thrown out of the coin outlet 142 by the push block 122 into the coin passage 20 in the track 2. When one coin 4 enters the coin passage 20, the coin 4 will push the floating members 241 upwards in the associating constraint grooves 242 and 243 so that the coin 4 can be moved upwards along the arched wall portion 211 of the bottom panel 21 at the bottom side of the coin passage 20 at an angle “a”. Because the arched wall portion 211 curves smoothly, the friction resistance between each coin 4 and the bottom panel 21 is low, i.e., the coin inserting force is low. Therefore, each coin 4 can be quickly moved along the arched wall portion 211 to the flat wall portion 212 of the bottom panel 21. Further, when one coin 4 is moved upwards beneath two or more anti-backward devices 24, the respective floating members 241 move downward along the bottom bearing surfaces 2431 of the respective constraint grooves 243 to hold down the coin 4. At this time, subject to the effect of self-gravity and friction, the coin 4 is held down by the respective floating members 241 that are moved to the ends of the bottom bearing surfaces 2431 of the respective constraint grooves 243. Thus, coins 4 can be moved upwards one by one in a proper order and are prohibited from backward movement or stacking. Therefore, the invention prevents track parts damage or motor overload.

Further, when one coin 4 is pushed upwards along the coin passage 20 to the coin-ejection device 3, the coin 4 will bias the coin-ejection element 32 to deform the spring member 321. When the coin 4 is continuously pushed upwards and moved out of the coin passage 20, the spring member 321 immediately returns to its former shape to return the coin-ejection element 32, causing the coin-ejection element 32 to eject the coin 4 out of the coin output port 311. At this time, the sensor module 33 senses the dispensing of the coin 4

The coin hopper with a push-up coin passage in accordance with the present invention that improves the drawbacks of the prior art designs are characterized by the technical features as follows:

1. The anti-backward devices 24 in the coin passage 20 of the track have the characteristics of simple structure and ease of installation. By means of using dispensed coins 4 to push the floating members 241 of the anti-backward devices 24 upwards, the force of inserting the dispensed coins 4 into the coin passage 20 is low. After insertion of one coin 4 into the coin passage 20 beneath two or more floating members 241, the effect of self-gravity and friction of the dispensed coin 4 causes the respective floating members 241 to move downwards to the ends of the bottom bearing surfaces 2431 of the respective constraint grooves 243 and then to hold down the dispensed coin 4, avoiding backward movement of the dispensed coin 4. Therefore, the coin hopper of the present invention has low failure rate and excellent anti-backward function characteristics and fits different sizes of coins.

2. The design of the anti-backward devices 24 allows coins 4 to push the floating members 241 upwards in the associating constraint grooves 242 and 243 so that coin 4 can be moved upwards along the arched wall portion 211 of the bottom panel 21 at the bottom side of the coin passage 20 smoothly at a predetermined sloping angle with less friction. Thus, the motor 131 can smoothly rotate the rotating disc 12 to dispense coins 4. Therefore, it is not necessary to upgrade the capacity of the motor 131 or to enhance the structural strength of the track 2, saving the cost.

3. When one coin 4 is inserted into the coin passage 20 beneath two or more anti-backward devices 24, the respective floating members 241 are caused to move downward along the bottom bearing surfaces 2431 of the respective constraint grooves 243 to hold down the coin 4 subject to the effect of self-gravity and friction. Thus, coins 4 can be moved upwards one by one in a proper order and are prohibited from backward movement or stacking. Therefore, the invention prevents track parts damage or motor overload.

Although a particular embodiment of the invention has been described in detail for purposes of illustration, various modifications and enhancements may be made without departing from the spirit and scope of the invention. For example, size of the coin passage 20 may vary with the size of the coins 4 to be dispensed. The coins 4 to be dispensed can be any of a variety of shapes (such as circular shape, polygonal shape, etc.) and sizes. Preferably, the coin hopper is adapted to dispense coins 4 of thickness within 1.6˜2.3 mm and diameter within 21˜26 mm. Further, the pitch between the floating members 241 of each two adjacent anti-backward devices 24 in the coin passage 20 is preferably about 10 mm. However, the design of the anti-backward devices 24 must allow coins 4 to be inserted into the coin passage 20 and moved along the arched wall portion 211 of the bottom panel 21 at a predetermined sloping angle “a” so that the floating members 241 of the anti-backward devices 24 can be moved upwards by coins 4 and then lowered to the ends of the bottom bearing surfaces 2431 of the respective constraint grooves 243 to hold down coins 4 on the flat wall portion 212, prohibiting coins 4 from backward movement or stacking with one another. Accordingly, the invention is not to be limited except as by the appended claims.

What the invention claimed is:

1. A coin hopper for dispensing coins, comprising:
a coin dispensing unit, said coin dispensing unit comprising a hopper body, a coin outlet, a rotating disc mounted in said hopper body and a power drive adapted for rotating said rotating disc to dispense coins out of said hopper body through said coin outlet; and
a track connected to said coin dispensing unit, said track comprising an arched wall portion smoothly upwardly curved from said coin outlet, a flat wall portion vertically upwardly extending from a top side of said arched wall portion, a coin passage defined by said arched wall portion and said flat wall portion and connected to said coin outlet for guiding coins out of said coin outlet one by one in a proper order, and a plurality of anti-backward devices arranged along the length of said coin passage above said arched wall portion and said flat wall portion, each said anti-backward device comprising a floating member movable up and down in said coin passage for allowing forward movement of coins one by one along said coin passage and prohibiting coins from backward movement.

2. The coin hopper as claimed in claim 1, wherein said coin dispensing unit further comprises a base frame, said base frame having a sloping top wall defining with a bottom wall of said hopper body said coin outlet; said rotating disc has a plurality of coin holes equiangularly arranged around the center thereof for dispensing coins and a push block protruded from the periphery thereof for pushing dispensed coins out of said hopper body toward said coin outlet; said power drive comprises a motor mounted inside said base frame and a transmission mechanism coupled between said motor and said rotating disc and rotatable by said motor to rotate said rotating disc.

3. The coin hopper as claimed in claim 2, wherein said base frame has a guide portion and a plurality of stop rods disposed in said coin outlet for guiding coins and allowing dispensed coins to be pushed by said push block of said rotating disc out of said coin outlet into said coin passage.

4. The coin hopper as claimed in claim 1, wherein said track comprises a bottom panel formed of said arched wall portion and said flat wall portion and extending along said coin passage at a bottom side, two narrow elongated guide bars respectively arranged at left and right sides relative to said coin passage and a cover plate covered on said two narrow elongated guide bars above said coin passage; said floating members of said anti-backward devices are mounted in between said cover plate and said two narrow elongated guide bars and movable up and down in said coin passage.

5. The coin hopper as claimed in claim 4, wherein each said anti-backward device further comprises a plurality of constraint grooves respectively formed in said narrow elongated guide bars and said cover plate for accommodating the associating floating member, each said constraint groove having a bottom bearing surface that gradually reduces in width in a direction away from said coin passage.

6. The coin hopper as claimed in claim 5, wherein the pitch between the floating members of each two adjacent anti-backward devices in said coin passage is preferably about 10 mm; the coins to be dispensed by the coin hopper preferably have a thickness within about 1.6˜2.3 mm and a diameter within about 21˜26 mm.

7. The coin hopper as claimed in claim 4, wherein said track further comprises a plurality of fastening members located on said cover plate for insertion through said narrow elongated guide bars and to affix said bottom panel and said narrow elongated guide bars to said cover plate.

8. The coin hopper as claimed in claim 1, further comprising a coin-ejection device located on a top side of said track remove from said coin dispensing unit, said coin-ejection device comprising a guide plate, said guide plate defining a coin output port in communication with said coin passage, a coin-ejection element pivotally connected to said guide plate and biasable by a coin dispensed out of said coin passage and a spring member connected between said coin-ejection element and said guide plate for reversing said coin-ejection element when said coin-ejection element is biased.

9. The coin hopper as claimed in claim 8, wherein said coin-ejection device further comprises a sensor module installed in said guide plate and adapted to detect the presence of a coin in said coin output port.
